(19) United States
(12) Patent Application Publication
(10) Pub. No.: US 2025/0145197 A1
(43) Pub. Date: May 8, 2025

(54) SYSTEMS AND METHODS FOR ADVANCED SCHEDULING AND OPTIMIZATION OF RAMP OPERATIONS OF A HUB BASED ON AN INTELLIGENT GRAPHICAL USER INTERFACE

(71) Applicant: BNSF Railway Company, Fort Worth, TX (US)

(72) Inventors: Dasaradh R. Mallampati, Trophy Club, TX (US); Vishal Badyal, Haslet, TX (US); Paul Kuhn, Fort Worth, TX (US); April Y. Kuo, Colleyville, TX (US)

(73) Assignee: BNSF Railway Company, Fort Worth, TX (US)

(21) Appl. No.: 18/911,803

(22) Filed: Oct. 10, 2024

Related U.S. Application Data
(63) Continuation-in-part of application No. 18/911,570, filed on Oct. 10, 2024.
Application No. 18/911,570 is a continuation-in-part of application No. 18/501,608, filed on Nov. 3, 2023, now Pat. No. 12,217,199.

(51) Int. Cl. B61L 27/16; B61L 27/04; G06F 3/0486

(52) U.S. Cl. CPC B61L 27/16; B61L 27/04; G06F 3/0486

(57) ABSTRACT

Systems and techniques for optimizing ramp operations of a hub based on a dual-stream resource optimization (DSRO) through an intelligent graphical user interface (GUI). The GUI dynamically visualizes an optimized ramp operations schedule, enabling operators to interact with and adjust the schedule of inbound and outbound trains. Re-optimization features adapt to changes made by the operator, maintaining efficient hub operations. The GUI's intelligent decision-making capabilities consider complex resource interdependencies and the cascading effects of schedule adjustments. Enhanced operational efficiency is achieved by providing alerts and notifications for deviations from the optimized plan, facilitating swift action. User-driven optimization offers operators the flexibility to select from multiple optimization options or maintain the original schedule. This intelligent GUI integration with the ramp operations optimization system advances intermodal hub management, driving efficiency and responsiveness.

### CROSS-REFERENCE TO RELATED APPLICATIONS

The present application is a continuation-in-part of pending and co-owned U.S. patent application Ser. No. 18/911,570, entitled “SYSTEM AND METHOD FOR OPTIMIZING RAMP OPERATIONS OF A HUB BASED ON A DUAL-STREAM RESOURCE OPTIMIZATION,” filed Oct. 10, 2024, which is a continuation-in-part of pending and co-owned U.S. patent application Ser. No. 18/501,608, entitled “SYSTEMS AND METHODS FOR INTERMODAL DUAL-STREAM-BASED RESOURCE OPTIMIZATION”, filed Nov. 3, 2023, the entireties of which are herein incorporated by reference for all purposes.

### TECHNICAL FIELD

The present disclosure relates generally to resource optimization systems, and more particularly to systems and devices for advanced scheduling and optimization of ramp operations of a hub based on an intelligent GUI.

### BACKGROUND

Intermodal hub facilities are pivotal nodes within the logistics and transportation network, serving as central points for the transfer and handling of goods across various transportation modes such as trains, trucks, and ships. The efficiency and effectiveness of these hubs are integral to the seamless flow of goods throughout the supply chain, which faces increasing demands due to the growth of global trade and the expectations for expedited delivery times.

A core function within these facilities is the management of ramp operations, which involve the scheduling and processing of inbound (IB) and outbound (OB) train operations. Inbound trains deliver units-key units in intermodal transport-bringing goods into the hub, while outbound trains load and transport goods away from the hub towards their final destinations. The performance of these operations has a direct impact on the throughput and operational costs of the hub.

The resources involved in ramp operations are diverse and finite, including but not limited to parking spots, hostlers, cranes, chassis, railcars, locomotives, and tracks. The optimization of these resources is a complex challenge that is pivotal for enhancing the hub's unit throughput and minimizing operational costs.

The inbound and outbound flows of units within the hub are distinct yet interconnected. Inbound units are typically deconsolidated and prepared for collection by consignees, while outbound units are consolidated and loaded for further transport. The synchronization of these flows requires precise scheduling and resource allocation to balance the delicate interplay between these processes. Scheduling the arrival and departure of trains is a multifaceted task that involves not just the timing but also the allocation of tracks and other resources. The overarching goal is to maximize resource utilization and ensure punctual train operations, often facilitated by employing traditional components such as events, jobs, and resources.

A time-space network is a common visualization tool used to plan and analyze the flow of units through a hub over a given period. This representation includes nodes representing processes and edges representing capacity, with the time dimension allowing for the analysis of node connectivity and unit flow under various operational scenarios.

Currently, operators at hubs may manually create a track-train assignment schedule to process the trains using a ramp planner graphical user interface (GUI) that provides a basic visual representation of the order of the schedule for each track of the hub. However, this approach is fraught with deficiencies. The ramp planner GUI, in its current form, is not equipped with intelligent decision-making capabilities, which means that any changes made to the schedule are not dynamically optimized based on the overall impact on hub operations. Furthermore, the ramp planner GUI does not provide an accurate visualization of the schedule, particularly from a temporal perspective. There is no indication of how long the trains take to be processed, which is a substantial limitation as it prevents operators from understanding the true operational flow and making informed decisions. The lack of temporal granularity in the visualization can lead to suboptimal resource allocation, scheduling conflicts, and ultimately, delays in the movement of goods through the hub.

Moreover, the manual approach to scheduling does not account for the complex interdependencies between various resources and the cascading effects that changes in one part of the schedule can have on other parts. This can result in inefficient use of resources, increased operational costs, and decreased unit throughput. The inability of the current ramp planner GUI to adapt to real-time changes in train arrivals and departures, resource availability, and other unforeseen operational contingencies further exacerbates these issues, highlighting the pressing need for a more sophisticated planning and optimization model.

### SUMMARY

The present disclosure achieves technical advantages as systems, methods, and computer-readable storage media for advanced scheduling and optimization of ramp operations of a hub based on an intelligent GUI. In embodiments, the intelligent GUI includes features that facilitate dynamic and efficient management of ramp operations. In embodiments, a system implemented in accordance with embodiments of the present disclosure identifies inbound and outbound trains scheduled to arrive at or depart from a hub within a planning horizon and generates a set of candidate track-train assignment sequences. These sequences are then optimized based on a dual-stream optimization model that includes both a consolidated time-space network and a deconsolidated time-space network. The intelligent GUI provide features that provide operators with an interactive and dynamic visual representation of ramp operations. It allows for real-time adjustments to the processing schedule of trains and the ability to request re-optimization based on operator-initiated changes. The intelligent GUI also enables operators to cycle through various proposed schedules, including those that may not be the absolute optimum but still meet operational objectives.

In embodiments, the present disclosure provides for a system integrated into a practical application with meaningful limitations, as an intelligent GUI manager that is integrated with a ramp operations optimization system, ensuring that a visualization on the intelligent GUI is an accurate reflection of the optimized ramp plan schedule. The intelligent GUI is not just a passive display but an active participant in the optimization process, enabling real-time interaction and decision-making that directly influences the ramp operations. The GUI manager represents an advanced tool that enhances the operator's control over ramp operations, and provides a comprehensive, temporally-aware visualization of the ramp plan, supports dynamic optimization and re-optimization based on operator input, and facilitates informed decision-making through interactive features and real-time notifications. The integration of the GUI manager with the ramp operations optimization system represents a technical improvement in the management of intermodal hub facilities, driving efficiency, responsiveness, and operational efficiency.

In embodiments, the intelligent GUI provides a temporally-aware visualization of the ramp plan, enabling operators to interact with the schedule and make informed decisions based on real-time data, which is pivotal for dynamic visualization and interaction. It goes a step further by allowing real-time re-optimization, in which the system dynamically adapts the ramp operations schedule in response to changes made by the operator, ensuring that the hub's operations remain efficient and responsive to the fluid nature of intermodal logistics. This capability is complemented by intelligent decision-making features integrated into the GUI, which consider the complex interdependencies between various resources and the cascading effects of schedule changes. To enhance operational efficiency, the GUI provides alerts and notifications to ensure that operators are promptly informed of any deviations from the optimized plan or emergent issues, enabling swift action to maintain operational flow. Furthermore, the intelligent GUI of embodiments offers user-driven optimization, empowering operators to select from multiple optimization options, which provides them with flexibility and control over the ramp operations schedule.

Thus, it will be appreciated that the technological solutions provided herein, and missing from conventional systems, are more than a mere application of a manual process to a computerized environment, but rather include functionality to implement a technical process to replace or supplement current manual solutions or non-existing solutions for optimizing resources in hubs. In doing so, the present disclosure goes well beyond a mere application the manual process to a computer. Accordingly, the disclosure and/or claims herein necessarily provide a technological solution that overcomes a technological problem.

Furthermore, the functionality for optimizing ramp operations in a hub facility provided by the present disclosure represents a specific and particular implementation that results in an improvement in the utilization of a computing system for resource optimization. Thus, rather than a mere improvement that comes about from using a computing system, the present disclosure, in enabling a system to leverage and optimize ramp operations to optimize the unit throughput of the hub over the planning horizon of the optimized operating schedule, represents features that result in a computing system device that can be used more efficiently and is improved over current systems that do not implement the functionality described herein. As such, the present disclosure and/or claims are directed to patent eligible subject matter.

In various embodiments, a system may comprise one or more processors interconnected with a memory module, capable of executing machine-readable instructions. These instructions include, but are not limited to, instruction configured to implement the steps outlined in any flow diagram, system diagram, block diagram, and/or process diagram disclosed herein, as well as steps corresponding to a computer program process for implementing any functionality detailed herein, whether or not described with reference to a diagram. However, in typical implementations, implementing features of embodiments of the present disclosure in a computing system may require executing additional program instructions, which may slow down the computing system's performance. To address this problem, the present disclosure includes features that integrate parallel-processing functionality to enhance the solution described herein.

In embodiments, the parallel-processing functionality of systems of embodiments may include executing the machine-readable instructions implementing features of embodiments of the present disclosure by initiating or spawning multiple concurrent computer processes. Each computer process may be configured to execute, process or otherwise handle a designated subset or portion of the machine-readable instructions specific to the disclosure's functionalities. This division of tasks enables parallel processing, multi-processing, and/or multi-threading, allowing multiple operations to be conducted or executed concurrently rather than sequentially. By integrating this parallel-processing functionality into the solution described in the present disclosure, a system markedly increases the overall speed of executing the additional instructions required by the features described herein. This not only mitigates any potential slowdown but also enhances performance beyond traditional systems. Leveraging parallel or concurrent processing substantially reduces the time required to complete sets or subsets of program steps when compared to execution without such processing. This efficiency gain accelerates processing speed and optimizes the use of processor resources, leading to improved performance of the computing system. This enhancement in computational efficiency constitutes a significant technological improvement, as it enhances the functional capabilities of the processors and the system as a whole, representing a practical and tangible technological advancement. The integration of parallel-processing functionality into the features of the present disclosure results in an improvement in the functioning of the one or more processors and/or the computing system, and thus, represents a practical application.

In embodiments, the present disclosure includes techniques for training models (e.g., machine-learning models, artificial intelligence models, algorithmic constructs, etc.) for performing or executing a designated task or a series of tasks (e.g., one or more features of steps or tasks of processes, systems, and/or methods disclosed in the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through an iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model's learning process. These features and techniques not only qualify as patent-eligible features but also introduce substantial improvements to the field of computational modeling. These features are not merely theoretical but represent an integration of a concepts into a practical application that significantly enhance the functionality, reliability, and efficiency of the models developed through these processes.

In embodiments, the present disclosure includes techniques for generating a notification of an event that includes generating an alert that includes information specifying the location of a source of data associated with the event, formatting the alert into data structured according to an information format, and/or transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet-centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet-centric problem with a solution that is necessarily rooted in computer technology. These features, when taken as an ordered combination, provide unconventional steps that confine the abstract idea to a particular useful application. Therefore, these features represent patent eligible subject matter.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a method of advanced scheduling and optimization of ramp operations of a hub based on an intelligent GUI. It is a further object of the disclosure to provide a system for advanced scheduling and optimization of ramp operations of a hub based on an intelligent GUI, and a computer-based tool for advanced scheduling and optimization of ramp operations of a hub based on an intelligent GUI. These and other objects are provided by the present disclosure, including at least the following embodiments.

In one particular embodiment, a method of advanced scheduling and optimization of ramp operations of a hub based on an intelligent GUI is provided. The method includes displaying, on the intelligent GUI, a representation of an optimized ramp operations schedule over a period of time for one or more inbound and outbound trains scheduled to be processed at a hub over the period of time. In embodiments, the representation of the optimized ramp operations schedule includes a graphical representation of a status of one or more production tracks of the hub over the period of time overlayed with a representation of the one or more inbound and outbound trains scheduled to be processed at the hub placed correspondingly to a time within the period of time at which the respective train is to be processed. The method also includes receiving, via the intelligent GUI, a user request to modify a processing time of at least one of the one or more inbound and outbound trains in the optimized ramp operations schedule, re-optimizing, by a ramp operations optimization system, the optimized ramp operations schedule based on the request to modify the processing time of the at least one of the one or more inbound and outbound trains to generate one or more optimized ramp operations schedule options, visually indicating, on the intelligent GUI, the one or more optimized ramp operations schedule options, committing one of the one or more optimized ramp operations schedule options for execution, and automatically sending, during execution of the optimized operating schedule, a control signal to a controller to cause execution of the committed re-optimized ramp operations.

In another embodiment, a system for advanced scheduling and optimization of ramp operations of a hub based on an intelligent GUI is provided. The system comprises at least one processor and a memory operably coupled to the at least one processor and storing processor-readable code that, when executed by the at least one processor, is configured to perform operations. The operations include displaying, on the intelligent GUI, a representation of an optimized ramp operations schedule over a period of time for one or more inbound and outbound trains scheduled to be processed at a hub over the period of time. In embodiments, the representation of the optimized ramp operations schedule includes a graphical representation of a status of one or more production tracks of the hub over the period of time overlayed with a representation of the one or more inbound and outbound trains scheduled to be processed at the hub placed correspondingly to a time within the period of time at which the respective train is to be processed. The operations also include receiving, via the intelligent GUI, a user request to modify a processing time of at least one of the one or more inbound and outbound trains in the optimized ramp operations schedule, re-optimizing, by a ramp operations optimization system, the optimized ramp operations schedule based on the request to modify the processing time of the at least one of the one or more inbound and outbound trains to generate one or more optimized ramp operations schedule options, visually indicating, on the intelligent GUI, the one or more optimized ramp operations schedule options, committing one of the one or more optimized ramp operations schedule options for execution, and automatically sending, during execution of the optimized operating schedule, a control signal to a controller to cause execution of the committed re-optimized ramp operations.

In yet another embodiment, a computer-based tool for advanced scheduling and optimization of ramp operations of a hub based on an intelligent GUI is provided. The computer-based tool including non-transitory computer readable media having stored thereon computer code which, when executed by a processor, causes a computing device to perform operations.

The operations include displaying, on the intelligent GUI, a representation of an optimized ramp operations schedule over a period of time for one or more inbound and outbound trains scheduled to be processed at a hub over the period of time. In embodiments, the representation of the optimized ramp operations schedule includes a graphical representation of a status of one or more production tracks of the hub over the period of time overlayed with a representation of the one or more inbound and outbound trains scheduled to be processed at the hub placed correspondingly to a time within the period of time at which the respective train is to be processed. The operations also include receiving, via the intelligent GUI, a user request to modify a processing time of at least one of the one or more inbound and outbound trains in the optimized ramp operations schedule, re-optimizing, by a ramp operations optimization system, the optimized ramp operations schedule based on the request to modify the processing time of the at least one of the one or more inbound and outbound trains to generate one or more optimized ramp operations schedule options, visually indicating, on the intelligent GUI, the one or more optimized ramp operations schedule options, committing one of the one or more optimized ramp operations schedule options for execution, and automatically sending, during execution of the optimized operating schedule, a control signal to a controller to cause execution of the committed re-optimized ramp operations.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an exemplary system configured with capabilities and functionality for advanced scheduling and optimization of ramp operations of a hub based on an intelligent graphical user interface (GUI) in accordance with embodiments of the present disclosure.

FIG. 2 is a block diagram illustrating an example of a DSRO system configured with capabilities and functionality for advanced scheduling and optimization of ramp operations of a hub based on an intelligent GUI in accordance with embodiments of the present disclosure.

FIG. 3 is a block diagram of an exemplary ramp operations optimization system configured with functionality for advanced scheduling and optimization of ramp operations of a hub based on an intelligent GUI in accordance with embodiments of the present disclosure.

FIG. 4A illustrates an exemplary intelligent GUI configured for advanced scheduling and optimization of ramp operations of a hub in accordance with embodiments of the present disclosure.

FIG. 4B illustrates the exemplary intelligent GUI configured for advanced scheduling and optimization of ramp operations of a hub in accordance with embodiments of the present disclosure.

FIG. 5 shows a high-level flow diagram of operation of a system configured for providing functionality for advanced scheduling and optimization of ramp operations of a hub based on an intelligent GUI in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

Various embodiments of the present disclosure are directed to systems and techniques that provide functionality for advanced scheduling and optimization of ramp operations of a hub based on an intelligent GUI. In embodiments, the intelligent GUI includes features that facilitate dynamic and efficient management of ramp operations. In embodiments, a system implemented in accordance with embodiments of the present disclosure identifies inbound and outbound trains scheduled to arrive at or depart from a hub within a planning horizon and generates a set of candidate track-train assignment sequences. These sequences are then optimized based on a dual-stream optimization model that includes both a consolidated time-space network and a deconsolidated time-space network. The intelligent GUI provide features that provide operators with an interactive and dynamic visual representation of ramp operations. It allows for real-time adjustments to the processing schedule of trains and the ability to request re-optimization based on operator-initiated changes. The intelligent GUI also enables operators to cycle through various proposed schedules, including those that may not be the absolute optimum but still meet operational objectives.

In embodiments, ramp operations of a hub may refer to both ramping operations in which units are loaded onto a train in a production track, and deramping operations in which units are unloaded from a train in a production track.

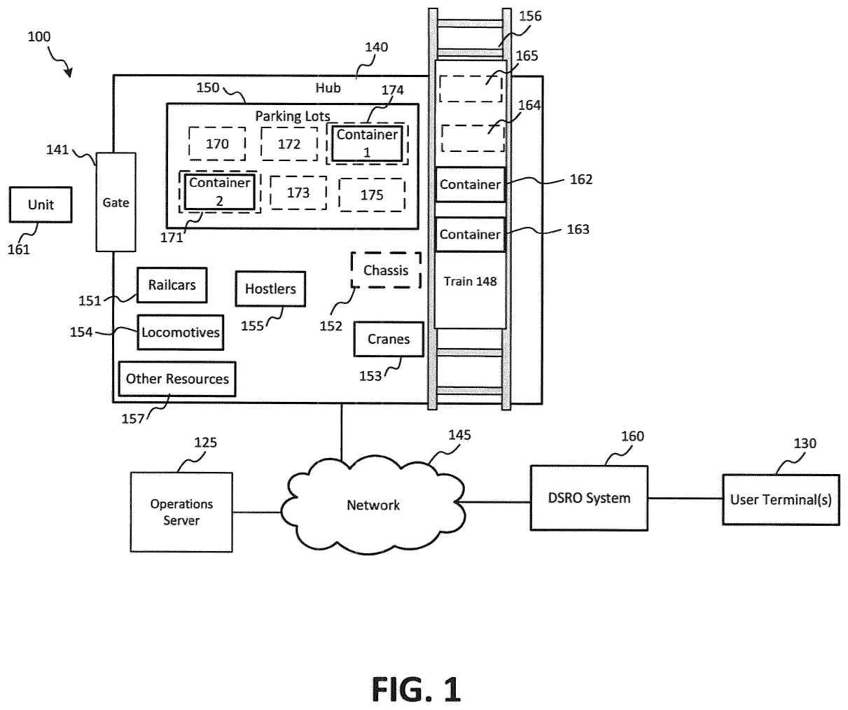

FIG. 1 is a block diagram of an exemplary system 100 configured with capabilities and functionality for advanced scheduling and optimization of ramp operations of a hub based on an intelligent GUI in accordance with embodiments of the present disclosure. As shown in FIG. 1, system 100 may include user terminal 130, hub 140, network 145, operations server 125, and DSRO system 160. These components, and their individual components, may cooperatively operate to provide functionality in accordance with the discussion herein.

It is noted that the functional blocks, and components thereof, of system 100 of embodiments of the present disclosure may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of system 100 described herein is provided for purposes of illustration, rather than by way of limitation and that functionalities described as being provided by different functional blocks may be combined into a single component or may be provided via computing resources disposed in a cloud-based environment accessible over a network, such as one of network 145.

User terminal 130 may include a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof. In embodiments, user terminal 130 may provide a user interface that may be configured to provide an interface (e.g., a graphical user interface (GUI)) structured to facilitate an operator interacting with system 100, e.g., via network 145, to execute and leverage the features provided by server 110. In embodiments, the operator may be enabled, e.g., through the functionality of user terminal 130, to provide functionality for managing operations of hub 140 in accordance with embodiments of the present disclosure. For example, an operator may provide information related to train schedules, information related to units arriving at hub 140, information related to configuration of the parking lots within hub 140, information related to production track configurations, to request parking spot assignments, etc. In an additional or alternative example, the operator may receive information related to ramping or deramping operations, etc. In embodiments, user terminal 130 may be configured to communicate with other components of system 100.

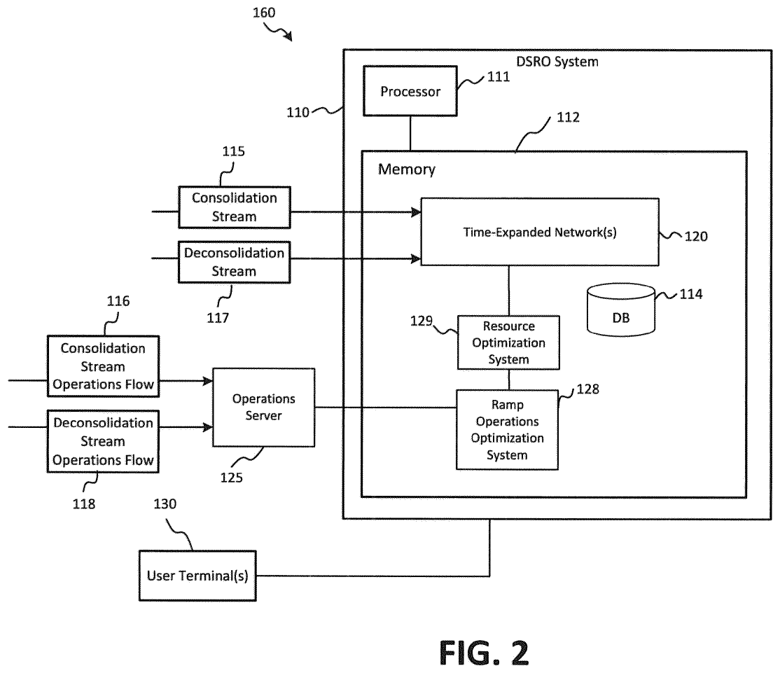

Furthermore, user terminal 130 may be configured to present or display the intelligent GUI of present embodiments, which may be a part of the advanced scheduling and optimization system of embodiments. The intelligent GUI is configured to provide operators with a dynamic and interactive visual representation of the ramp operations, including real-time status of trains, tracks, and associated resources. Through the intelligent GUI, operators may not only view the optimized ramp plan schedule (e.g., as generated by ramp operations optimization system 128 of FIG. 2, but may also interact with it by making adjustments to train schedules, track assignments, and resource allocations. These interactions are facilitated by intuitive controls and visual cues that allow for easy manipulation of the ramp plan elements within the GUI. The intelligent GUI also provides alerts and notifications to the operator, ensuring that any deviations from the optimized plan or emergent issues are promptly addressed. By integrating the intelligent GUI with the user terminal 130, the system empowers operators to maintain a high level of situational awareness and control over the ramp operations, leading to improved decision-making and operational efficiency.

In embodiments, network 145 may facilitate communications between the various components of system 100 (e.g., hub 140, DSRO system 160, and/or user terminal 130). Network 145 may include a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc.

Hub 140 may represent a hub (e.g., an IHF, a train station, etc.) in which units are processed as part of the transportation of the units. In embodiments, a unit may include containers, trailers, etc., carrying goods. For example, a unit may include a chassis carrying a container, and/or may include a container. In embodiments, units may be in-gated (IG) into hub 140 (e.g., by a customer dropping the unit into hub 140). The unit, including the chassis and the container (e.g., the chassis carrying the container), may be temporarily stored in a parking space of parking lots 150, while the container awaits being assigned to an outbound train. Once assigned to an outbound train, and once the outbound train is assigned to a production track (e.g., production tracks 156), the outbound train is placed on the production track and the container is moved from the parking spot in which the container is currently stored to the production track, where the container is removed from the chassis and the container is loaded or ramped onto the outbound train for transportation to the destination of the container. On the other side of operations, a container carrying goods may arrive at the hub via an inbound (IB) train (e.g., the inbound train may represent an outbound train from another hub from which the container may have been loaded), may be unloaded or deramped from the inbound train and may be temporarily stored in a parking spot of parking lots 150 for eventual pickup by a customer.

Hub 140 may be described functionally by describing the operations of hub 140 as comprising two distinct flows or streams. Units (e.g., containers being carried in chassis) flowing through a first flow (e.g., an IG flow) may be received through gate 141 from various customers for eventual ramping onto an appropriate outbound train. For example, customers may drop off individual units (e.g., unit 161 including a container being carried in a chassis) at hub 140. The containers arriving through the IG flow may be destined for different destinations, and may be dropped off at hub 140 at various times of the day or night. As part of the IG flow, the containers arriving at hub 140, along with the chassis in which these containers arrive, may be assigned or allocated to parking spots in one or more of parking lots 150, while these containers wait to be assigned to and ramped onto an outbound train bound to the respective destination of the containers. Once an outbound train is ready to be ramped, the outbound train (e.g., train 148) may be assigned to and placed on a production track (e.g., production track 156). At this point, the containers assigned to the outbound train may be moved from their current parking spot to the production track to be ramped onto the outbound train to be taken to their respective destination.

Units flowing through a second flow (e.g., an IB flow) may arrive at hub 140 via an inbound train (e.g., train 148 may arrive at hub 140), carrying containers, such as containers 162, 163, and/or other containers, which may eventually be deramped from the inbound train to be placed onto chassis, assigned to and parked in parking spots of parking lot 150 to be made available for delivery to (e.g., for pickup by) customers.

For example, unit 141, including a container being carried in a chassis, may be currently being dropped off into hub 140 by a customer as part of the IG flow of hub 140, and may be destined to a first destination. In this case, as part of the IG flow, unit 141 may be in-gated into hub 140 and may be assigned to a parking spot (e.g., parking spot 175) in one of parking lots 150. In this example, container 1 may have been introduced into the IG flow of hub 140 by a customer (e.g., the same customer or a different customer) previously dropping off container 1 at hub 140 to be transported to some destination (e.g., the first destination or a different destination), and may have previously been assigned to parking spot 174 of parking lots 150, where container 1 may currently be waiting to be assigned and/or loaded onto an outbound train to be transported to the destination of container 1.

As part of the IG flow, the container in unit 141 and container 1 may be assigned to an outbound train. For example, in this particular example, train 148 may represent an outbound train that is schedule to depart hub 140 to the same destination as the container in unit 141 and container 1. In this example, the container in unit 141 and container 1 may be assigned to train 148. Train 148 may be placed on one of one or more production track 156 to be ramped. In this case, as part of the IG flow, train 148 is ramped (e.g., using one or more cranes 153) with containers, including the container in unit 141 and container 1. Once loaded, train 148 may depart to its destination as part of the IG flow.

With respect to the IB flow, train 148 may arrive at hub 140 carrying several containers, including containers 2, 162, and 163. It is noted that, as part of the dual stream operations of hub 140, some resources are shared and, in this example, train 148 may arrive at hub 140 as part of the IB flow before being loaded with containers as part of the IG flow as described above. Train 148 may be placed on one of one or more production tracks 156 to be unloaded a part of the IB flow. As part of the deramping operations, the containers being carried by train 148 and destined for hub 140, may be removed from train 148 (e.g., using one or more cranes 153) and each placed or mounted on a chassis. Once on the chassis, the containers are transported (e.g., using one or more hostlers 155) to an assigned parking spot of parking lots 150 to wait to be picked up by respective customers at which point the containers and the chassis on which the containers are mounted may exit or leave hub 140. For example, container 2 may be assigned to and parked on parking spot 172.

In embodiments, processing the units through the IG flow and the IB flow may involve the use of a wide variety of resources to consolidate the units from customers into outbound trains and/or to deconsolidate inbound trains into units for delivery to customers. These resources may include hub personnel (hostler drivers, crane operators, etc.), parking spaces, chassis, hostlers, cranes, tracks, railcars, locomotives, etc. These resources may be used to facilitate holding and/or moving the units through the operations of the hub.

For example, parking lots 150 may be used to park or store units while the units are waiting to be assigned to and loaded onto outbound trains or waiting to be picked up by customers. Parking lots 150 of hub 140 may include a plurality of parking lots, each of which may include a plurality of parking spots. In the example illustrated in FIG. 1, parking lots may include parking spots 170-175. In embodiments, parking lots 150 may represent physical parking lots that may be configured with a particular layout, orientation with respect to the production tracks of hub 140, and/or distance from the production tracks. In some embodiments, the various parking lots of parking lots 150 may have different categories, based on the accessibility to the production tracks 156 from the respective parking lots. For example, some parking lots may be categorized as beachfront parking lots, high-priority hub parking lots, low-priority hub parking lots, offsite parking lots, stacked parking lots, etc. During operations, units arriving at hub 140 may be allocated to parking lot categories, in which case a unit allocated to a particular parking lot category may be assigned to a parking spot in a parking lot having the allocated particular parking lot category.

Chassis 152 (e.g., including, trucks, forklifts, and/or any structure configured to securely carry a container), and operators of chassis 152, may be used to securely carry units within hub 140. Hostlers 155 (e.g., including hostler operators, etc.) may be used to transport or move the units (e.g., containers on chassis) within hub 140, such as moving units to be loaded onto an outbound train or to move units unloaded from inbound trains. Cranes 153 may be used to load units onto departing trains (e.g., to unload units from chassis 152 and load the units onto the departing trains), and/or to unload units from arriving trains (e.g., e.g., to unload units from arriving trains and load the units onto chassis 152). Railcars 151 may be used to transport the units in the train. For example, a train may be composed of one or more railcars, and the units may be loaded onto the railcars for transportation. Arriving trains may include one or more railcars including units that may be processed through the second flow, and departing trains may include one or more railcars including units that may have been processed through the first flow. Railcars 151 may be assembled together to form a train. Locomotives 154 may include engines that may be used to power a train. Other resources 157 may include other resources not explicitly mentioned herein but configured to allow or facilitate units to be processed through the first flow and/or the second flow.

In embodiments, operations server 125 may be configured to provide functionality for facilitating operations of hub 140. In embodiments, operations server 125 may include data and information related to operations of hub 140, such as current inventory of all hub resources (e.g., chassis, hostlers, drivers, lift capacity, parking lot and parking spaces, IG capacity limits, railcar, locomotives, tracks, etc.). This hub resource information included in operations server 125 may change over time as resources are consumed, replaced, and/or replenished, and operations server 125 may have functionality to update the information. Operations server 125 may include data and information related to inbound and/or outbound train schedules (e.g., arriving times, departure times, destinations, origins, capacity, available spots, inventory list of units arriving in inbound trains, etc.). In particular, inbound train schedules may provide information related to inbound trains that are scheduled to arrive at the hub during the planning horizon an optimized operating schedule (as described herein), which may include scheduled arrival time, origin of the inbound train, capacity of the inbound train, a list of units loaded onto the inbound train, a list of units in the inbound train destined for the hub (e.g., to be dropped off at the hub), etc. With respect to outbound train schedules, the outbound train schedules may provide information related to outbound trains that are scheduled to depart from the hub during the planning horizon, including scheduled departure time, capacity of the outbound train, a list of units already scheduled to be loaded onto the outbound train, destination of the outbound train, etc. In embodiment, the information from operations server 125 may be used (e.g., by DSRO system 160) to develop, generate, and/or update an optimized operating schedule based on a DSRO for managing the resources of hub 140 over a planning horizon.

In embodiments, operations server 125 may provide functionality to manage the execution of the optimized operating schedule (e.g., an optimized operating schedule generated in accordance with embodiments of the present disclosure) over the planning horizon of the optimized operating schedule. The optimized operating schedule may represent recommendations made by DSRO system 160 of how units arriving at each time increment of the planning horizon are to be processed, and how resources of hub 140 are to be managed to maximize unit throughput through the hub over the planning horizon of the optimized operating schedule. For example, the optimized operating schedule may include recommendations associated with ramping and deramping operations. For example, the optimized operating schedule may include recommendations on which production tracks to assign inbound and outbound trains for processing. Processing an inbound train may include deramping or unloading the units carried in the train and scheduled to be unloaded at the hub. Processing an outbound train may include ramping or loading the units to be carried by the outbound train to their destination.

In embodiments, operations server 125 may manage execution of the optimized operating schedule by monitoring the consolidation stream operations flow (e.g., consolidation stream operations flow 116 of FIG. 2, which may represent the actual unit traffic flow through the IG flow during execution of the optimized operating schedule) and deconsolidation stream operations flow (e.g., deconsolidation stream operations flow 118 of FIG. 2, which may represent the actual unit traffic flow through the IB flow during execution of the optimized operating schedule) to ensure that the optimized operating schedule is being executed properly, and to update the optimized operating schedule based on the actual unit traffic, which may impact resource availability and/or consumption, especially when the actual unit traffic during execution of the optimized operating schedule differs from the predicted unit traffic used in the generation of the optimized operating schedule. In embodiments, operations server 125 may operate to provide functionality that may be leveraged during execution of the optimized operating schedule over a planning horizon to ensure that unit throughput through the hub is maximized over the planning horizon.

DSRO system 160 may be configured to manage resources of hub 140 based on a DSRO to maximize throughput through hub 140 over the planning horizon in accordance with embodiments of the present disclosure. In particular, DSRO system 160 may be configured to provide the main functionality of system 100 to manage the interactive visual representation of the ramp operations, provide operators with real-time status updates of trains, tracks, and associated resources, by implementing the intelligent GUI of embodiments. DSRO system 160 facilitates the interaction with the optimized ramp plan, allowing operators to make informed decisions by adjusting train schedules, track assignments, and resource allocations directly through the intelligent GUI. DSRO system 160 may provide the functionality of the intelligent GUI by leveraging the functionality of a GUI manager of a ramping operations optimization system (e.g., ramping operations optimization system 128 of FIG. 2) as described in more detail herein.

DSRO system 160 may also provide functionality to optimize the ramping operations of hub 140 to generate an optimized ramp plan (e.g., a sequence of track-train assignments of inbound and/or outbound trains, in chronological order) that is configured to maximizing the utilization of the hub resources, and to meet predefined objectives (e.g., maximized on-time-performance, optimized total processing time, optimized track utilization, etc.). In embodiments, DSRO system 160 may optimize the ramping operations of hub 140 over the planning horizon of the optimized operating schedule by leveraging the functionality of an optimization system of a ramping operations optimization system (e.g., ramping operations optimization system 128 of FIG. 2) that may include functionality to dynamically assess hub resource availability at intermediate time increments of the planning horizon and to evaluate the demand for resources by varying sequences of train ramping operations. The ramping operations optimization system meticulously analyzes different permutations of inbound and outbound train sequences (e.g., different sequences of train processing in one or more production tracks) over the planning horizon, along with the requisite intermediate setups, to select the optimum train sequence for each production track within the hub facility based on predetermined effort matrices. The ramping operations optimization system's objectives can be tailored to prioritize on-time performance or to maximize resource utilization, depending on operational priorities.

FIG. 2 is a block diagram illustrating an example of DSRO system 160 configured with capabilities and functionality for advanced scheduling and optimization of ramp operations of a hub based on an intelligent GUI in accordance with embodiments of the present disclosure. As shown in FIG. 2, DSRO system 160 may be implemented in a server (e.g., server 110). In embodiments, functionality of server 110 to facilitate operations of DSRO system 160 may be provided by the cooperative operation of the various components of server 110, as will be described in more detail below.

It is noted that although FIG. 2 shows server 110 as a single server, it will be appreciated that server 110 (and the individual functional blocks of server 110) may be implemented as separate devices and/or may be distributed over multiple devices having their own processing resources, whose aggregate functionality may be configured to perform operations in accordance with the present disclosure. Furthermore, those of skill in the art would recognize that although FIG. 2 illustrates components of server 110 as single and separate blocks, each of the various components of server 110 may be a single component (e.g., a single application, server module, etc.), may be functional components of a same component, or the functionality may be distributed over multiple devices/components. In such embodiments, the functionality of each respective component may be aggregated from the functionality of multiple modules residing in a single, or in multiple devices. In addition, particular functionality described for a particular component of server 110 may actually be part of a different component of server 110, and as such, the description of the particular functionality described for the particular component of server 110 is for illustrative purposes and not limiting in any way.

As shown in FIG. 2, server 110 includes processor 111, memory 112, time-expanded network 120, ramp operations optimization system 128, resources optimization system 129, and database 114.

Processor 111 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some embodiments, implementations of processor 111 may comprise code segments (e.g., software, firmware, and/or hardware logic) executable in hardware, such as a processor, to perform the tasks and functions described herein. In yet other embodiments, processor 111 may be implemented as a combination of hardware and software. Processor 111 may be communicatively coupled to memory 112.

Memory 112 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. Memory 112 may comprise a processor readable medium configured to store one or more instruction sets (e.g., software, firmware, etc.) which, when executed by a processor (e.g., one or more processors of processor 111), perform tasks and functions as described herein.

Memory 112 may also be configured to facilitate storage operations. For example, memory 112 may comprise database 114 for storing various information related to operations of system 100. For example, database 114 may store configuration information related to operations of DSRO system 160. In embodiments, database 114 may store information related to various models used during operations of DSRO system 160, such as a DSRO model, a parking lot optimization model, a parking lot classification model, an ingate prediction model, an inbound prediction model, a unit diffusion model, a hostler route operations optimization model, a multihop operations optimization model, a ramp operations optimization model, etc. Database 114 is illustrated as integrated into memory 112, but in some embodiments, database 114 may be provided as a separate storage module or may be provided as a cloud-based storage module. Additionally, or alternatively, database 114 may be a single database, or may be a distributed database implemented over a plurality of database modules.

As mentioned above, operations of hub 140 may be represented as two distinct flows, an IG flow in which units arriving to hub 140 from customers are consolidated into outbound trains to be transported to their respective destinations, and an IB flow in which inbound trains arriving to hub 140 carrying units are deconsolidated into the units that are stored in parking lots while waiting to be picked up by respective customers. DSRO system 160 may be configured to represent the IG flow as consolidation stream 115 including a plurality of stages. Each stage of consolidation stream 115 may represent different operations or events that may be performed or occur to facilitate the IG flow of hub 140. DSRO system 160 may be configured to represent the IB flow as deconsolidation stream 117 including a plurality of stages. Each stage of deconsolidation stream 117 may represent different operations or events that may be performed or occur to facilitate the IB flow of hub 140.

Each of the consolidation stream 115 and deconsolidation stream 117 may include various stages. For example, consolidation stream 115 may be configured to include a plurality of stages, namely an in-gated (IG) stage, an assignment (AS) stage, a ramping (RM) stage, a release (RL) stage, and a departure (TD) stage. Deconsolidation stream 115 may be configured to include a plurality of stages, namely an arrival (TA) stage, a strip track placement (ST-PU) stage, a de-ramping (DR) stage, a unit park and notification (PN) stage, and an out-gated (OG) stage. In embodiments, each of the stages of each of consolidation stream 115 and deconsolidation stream 117 may represent an event or operations that may be performed or occur to facilitate the flow of a unit through each of the streams.

In particular, the RM stage of consolidation stream 115 may represent ramping operations of the IG flow in which units may be loaded onto an outbound train for transportation to the destination of the container. In embodiment, during the RM stage, the units may be assigned to a railcar of an outbound train, such as based on the unit's destination and/or the desired delivery time, such as based on a scheduled train lineup. During this stage, the outbound train may be assigned to a production track and may be placed in the production track for loading. In particular, the RM stage of consolidation stream 115 may operate to consolidate containers with a same destination (or with a destination that is within a particular route) into the outbound train. During the RM stage of consolidation stream 115.

In embodiments, at the ST-PU stage of deconsolidation stream 117, an inbound train may be spotted and placed on a production track for unloading. In embodiments, the resources involved in the ST-PU stage may include the production tracks used to place the inbound train, the locomotive used to power the inbound train into the production track, and the railcars that are part of the inbound train. The DR stage of deconsolidation stream 117 may represent deramping operations of the IB flow. During the DR stage, units being carried by the inbound train may be unloaded or deramped from the inbound train. Again, a host of hub resources may be used during the DR stage of deconsolidation stream 117.

In embodiments, DSRO system 160 may be configured to optimize the use of resources and operations to maximize the throughput of the hub (e.g., the rate of units processed through the hub) by generating one or more time-expanded networks 120 to represent consolidation stream 115 and deconsolidation stream 117, and configuring the DSRO model to use one or more time-expanded networks 120, over a planning horizon, to optimize the use of the resources of the hub that support the unit flow within the planning horizon to maximize the throughput of units over the planning horizon. In embodiments, the DSRO model may generate, based on the one or more time-expanded networks 120, an optimized operating schedule that includes one or more of a determined unit flow through one or more of the stages of time-expanded network (e.g., the consolidation and/or deconsolidation stream time-expanded networks) at each time increment of the planning horizon, an indication of a resource deficit or overage at one or more of the stages of each time-expanded network at each time increment of the planning horizon, and/or an indication or recommendation of a resource replenishment to be performed at one or more of the stages of each time-expanded network at each time increment of the planning horizon to ensure the optimized operating schedule is met.

Particular to the present disclosure, the optimized operating schedule may include recommendations for ramping and/or deramping operations at each time increment of the planning horizon of the optimized operating schedule configured to maximize the unit throughput within the hub during execution of the optimized operating schedule. The ramping and/or deramping operation recommendations may include recommendations on how to perform ramping operations and/or deramping operations at each time increment of the planning horizon, as well as recommendations related to the assignment of trains (e.g., inbound and/or outbound trains) to production tracks, which may be referred to as track-train assignments, for processing of the trains (e.g., for unlading or deramping and/or loading or ramping). In this manner, during execution of the optimized operating schedule, operators may perform ramping operations and/or deramping operations according to the recommendations in the optimized operating schedule to ensure that the unit throughput of the hub over the planning horizon of the optimized operating schedule is maximized.

In embodiments, DSRO system 160 may be configured to apply the DSRO model to the time-expanded networks 120 to optimize the use of the by the consolidation and deconsolidation streams over the planning horizon to maximize the unit throughput of the hub over the planning horizon to generate the optimized operating schedule. To that end, DSRO 160 may include a plurality of optimization systems. For example, resource optimization system 129 may be configured to generate, based on the DSRO model, an optimized operating schedule that may be implemented over a planning horizon to maximize throughput of units through the hub. In particular, resource optimization manager 129 may be configured to consider resource availability (e.g., resource inventory), resource replenishment cycles, resource cost, operational implications of inadequate supply of resources, for all the resources involved in the consolidation and deconsolidation streams to determine the optimized operating schedule that may maximize throughput through the hub over the planning horizon. Resource optimization manager 129 may be configured to additionally consider unit volumes (e.g., unit volumes expected to flow during the planning horizon through the consolidation stream and the deconsolidation streams, such as at each time increment of the planning horizon) and unit dwell times (e.g., expected dwell times of units flowing through the consolidation stream and the deconsolidation streams during the planning horizon) to determine the optimized operating schedule that may maximize throughput through the hub over the planning horizon.

During operations (e.g., during execution of the operating schedule, when units arrive at the hub), operations server 125 may operate to manage execution of the optimized operating schedule by monitoring consolidation stream operations flow 116 (e.g., the actual traffic flow through the consolidation stream 115 during execution of the optimized operating schedule) and deconsolidation stream operations flow 118 (e.g., the actual traffic flow through the deconsolidation stream 117 during execution of the optimized operating schedule) to ensure that the optimized operating schedule is being executed properly, and to update the optimized operating schedule based on the actual unit traffic, which may impact resource availability and/or consumption, especially when the actual unit traffic during execution of the optimized operating schedule differs from the predicted unit traffic used in the generation of the optimized operating schedule.

In embodiments, the functionality of DSRO system 160 to optimize the ramp operations of the hub may include leveraging the functionality of ramp operations optimization system 128. Ramp operations optimization system 128 may be configured to optimize ramp operations of the hub by dynamically assessing resource availability at time increments of the planning horizon and evaluating the demand for resources by varying sequences of ramp operations. For example, ramp operations optimization system 128 may analyze different permutations of inbound and outbound train processing sequences (e.g., different sequences of processing (e.g., deramping or ramping inbound and/or outbound trains) of trains in chronological order for each of the production tracks) over the planning horizon, along with the requisite intermediate setups, to select the optimal train sequence for each production track within the hub facility.

Ramp operations optimization system 128 may also be configured to provide functionality for leveraging the ramp operations optimization functionality of ramp operations optimization system 128 by providing an intelligent GUI that may be configured to provide an interactive interface through which an operator can visualize the optimized ramp operations schedule, make changes to the schedule, and trigger the model to re-optimize the schedule based on those changes. The intelligent GUI may include various selectable elements that allow the operator to interact with the schedule in a dynamic and efficient manner. The intelligent GUI of embodiment represents an innovative addition to the ramp operations optimization system, focusing on the user interface and interaction aspects, and it serves as the conduit through which the optimization model's capabilities are made accessible and actionable to operators.

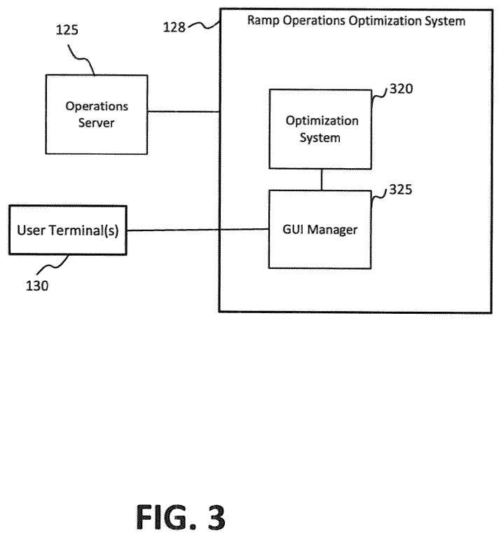

Operations of ramp operations optimization system 128 will now be discussed with respect to FIG. 3. FIG. 3 is a block diagram of an exemplary ramp operations optimization system 128 configured with functionality for advanced scheduling and optimization of ramp operations of a hub based on an intelligent GUI in accordance with embodiments of the present disclosure. As shown in FIG. 3, ramp operations optimization system 128 may optimization system 320 and GUI manager 325.

Optimization system 320 is a central component of the ramp operations optimization system 128, configured to generate an optimized ramp plan schedule for the hub facility. The optimized ramp plan schedule is a comprehensive framework that outlines the strategic allocation and sequencing of inbound and outbound trains on the production tracks within the hub over a specified planning horizon, or at least a portion of the planning horizon. This planning horizon may encompass a full operational day or a portion thereof, segmented into discrete time increments that allow for precise scheduling and resource allocation.

The generation of the optimized ramp plan schedule by optimization system 320 involves a multi-step process that leverages a combination of predictive analytics, historical data, and real-time operational inputs. Optimization system 320 may be configured to maximize the utilization of the hub's finite resources, which may include but are not limited to parking spots, hostlers, cranes, chassis, railcars, locomotives, and tracks. By doing so, optimization system 320 aims to enhance the hub's unit throughput and minimize operational costs while ensuring punctual train operations.

The process of generating the optimized ramp plan schedule begins with the identification of all inbound and outbound trains expected to arrive at or depart from the hub within the planning horizon (or a portion thereof). Optimization system 320 analyzes the active train schedule, which provides detailed information on the timing, train types, and resource requirements of each scheduled train operation. Additionally, or alternatively, optimization system 320 may employ predictive models to forecast unscheduled train movements based on historical patterns, thereby preempting potential resource allocation challenges.

Once the set of trains to be processed within the planning horizon is identified, optimization system 320 may proceed to enumerate all possible track-train assignment sequences. These sequences encompass various combinations of train operations, each characterized by distinct resource requirements and temporal constraints. Optimization system 320 may consider the intricate interdependencies among the diverse resources, such as parking spots, hostlers, cranes, chassis, railcars, locomotives, and tracks in enumerating the set of possible track-train assignment sequences (e.g., the set of candidate possible track-train assignment sequences). Optimization system 320 may also evaluate the cascading effects that any alterations in one segment of the schedule may precipitate across other segments. This comprehensive analysis ensures that optimization system 320 may can adeptly navigate the complex dynamics of resource allocation and scheduling, facilitating the development of a robust and efficient operational plan for the hub.

To refine the set of candidate sequences, optimization system 320 may employ a pruning algorithm that eliminates infeasible sequences. A sequence may be deemed infeasible if it violates the hub's operational constraints, such as insufficient turnaround time between train operations on the same track or inadequate resource availability to support concurrent train processing.

Following the pruning step, optimization system 320 may quantify the cost associated with each remaining candidate sequence. The cost determination is based on effort matrices that encapsulate the setup, processing, and teardown efforts for each train pair within a sequence. These matrices consider the specific resources and subprocesses associated with each train type, enabling the system to evaluate the operational impact of each sequence.

With the costs quantified, optimization system 320 may apply a mathematical optimization model to select the sequence that minimizes the total cost while adhering to the hub's operational objectives. The chosen sequence may be included in the optimized ramp plan schedule, which is then communicated to the relevant operational teams for implementation.

The optimized ramp plan schedule may represent a comprehensive framework that outlines the strategic allocation and sequencing of inbound and outbound trains on the production tracks within the hub over a specified planning horizon. This planning horizon may encompass a full operational day or a portion thereof, segmented into discrete time increments that allow for precise scheduling and resource allocation. The optimized ramp plan schedule may represent one or more sequences where each sequence may represent successive assignments on the same production track and/or concurrent assignments over more than one production track. In this manner, the optimized ramp schedule represents the optimized schedule of track-train assignments to one or more production tracks over the planning horizon. Successive assignments involve the sequential processing of trains on a single track, where the resources from a departing train may be utilized by the subsequent train. Concurrent assignments involve the simultaneous processing of trains on multiple tracks, requiring a coordinated approach to resource allocation across the hub to ensure efficient operations. The optimized ramp plan schedule is designed to maximize the utilization of the hub's finite resources, enhance throughput, and minimize operational costs while ensuring punctual train operation.

The optimized ramp plan schedule is dynamic and can adapt to real-time changes in train arrivals, resource availability, and other unforeseen operational contingencies. Optimization system 320 continuously monitors the execution of the ramp plan and can re-optimize the schedule in response to deviations from the plan or emergent issues, ensuring that the hub's operations remain efficient and responsive to the fluid nature of intermodal logistics.

GUI manager 325 is configured to provide the main functionality to generate, provide, and/or display the intelligent GUI of embodiments. The intelligent GUI of embodiments is configured to facilitate the interaction between the operator and the advanced scheduling and optimization functionalities of ramp operations optimization system 128. In this manner, the intelligent GUI provided by GUI manager 325 serves as the interface through which an operator can visualize, manage, and interact with the optimized ramp plan schedule generated by the optimization system 320.

In embodiments, GUI manager 325 may be configured to present the operator with an intelligent GUI that provides a dynamic and interactive visual representation of the ramp operations. The intelligent GUI is configured to display the production tracks of the hub facility over the planning horizon, along with graphical representations of the inbound and outbound trains scheduled for processing on these tracks. In embodiments, the intelligent GUI may be structured to reflect the temporal dimension of the ramp operations, with trains positioned along a timeline to indicate the duration of their processing, where the length of the train representation with respect to the graphical timeline corresponds to the processing duration of the train.

In embodiments, the intelligent GUI enables the operator to view the optimized track-train assignment schedule, which may include successive and/or concurrent track-train assignments. Successive track-train assignments are depicted as sequential processing of trains on a single track, with visual cues indicating the transfer of resources from a departing train to the subsequent one. Concurrent assignments are shown as simultaneous processing of trains on multiple tracks, with the GUI providing insights into the coordinated resource allocation across the hub.

In embodiments, GUI manager 325 may be configured to enable operators to make adjustments to the ramp plan using the intelligent GUI. For example, operators can interact with the GUI to slide train representations to different times or tracks, signifying changes to the processing schedule. These changes are not merely superficial, as GUI manager 325, in conjunction with the optimization system 320, may validate the feasibility of these changes in real-time, considering the availability of resources and the impact on other scheduled train operations.

In embodiments, the validation of a change to the processing schedule of a train may be performed automatically by the system, or may be in response to a request by the operator. For example, the intelligent GUI may also feature a selectable element (e.g., a “re-optimize” selectable element or similar feature) which, when activated, may cause ramp operations optimization system 128 to perform the ramp operations optimization process as described herein, but considering the proposed change to the processing schedule of the train. For example, the operator may request (e.g., through interaction with a selectable graphical element of the intelligent GUI, such as a “re-optimize button”) a re-optimization of the ramp operations plan schedule based on the requested change to the processing schedule of the train. In response to the request, GUI manager may cause ramp operations optimization system 128 to evaluate the proposed change to the processing schedule and to provide feedback.

In embodiments, ramp operations optimization system 128 may determine (e.g., by leveraging the functionality of optimization system 320) whether the ramp plan schedule including the proposed change to the processing schedule represents a feasible ramp plan schedule. In this case, in response to a determination that the proposed changes are supported by the available resources or is feasible, GUI Manager 325 dynamically adapts the schedule to incorporate the modifications. For example, a current ramp plan schedule may include a train being processed at a production track from 08:00 hours to 14:00. In this example, the operator, using the intelligent GUI, may slide the train to a new timeframe including from 11:00 hours to 17:00 hours. In this case, rather than merely allowing the change to the processing schedule of the train without changing anything else of the ramp plan schedule, ramp operations optimization system 128, automatically or after a request to re-optimize, may re-optimize the ramp plan schedule based on the change to the processing schedule of the train to the timeframe of 11:00 hours to 17:00 hours.

In alternative or additional embodiments, ramp operations optimization system 128 may suggest alternative ramp plan schedules that may be optimized based on the proposed change to the processing schedule of the train. In these embodiments, the alternative ramp plan schedules represent improved schedules over merely allowing the proposed change to be incorporated into the current ramp plan schedule. For example, following the example above, GUI Manager 325 may present one or more alternative ramp plan schedules, including the train being process during the new timeframe of 11:00 hours to 17:00 hours, that result in a more optimal ramp plan schedule than merely allowing the change without making any other changes to the ramp plan schedule.

In embodiments, the re-optimization the ramp plan schedule may include reassessing the allocation of resources, the sequencing of train operations, and the timing of each train's processing. Ramp operations optimization system 128 may take into account the new parameters introduced by the requested changes and may recalculates the cost associated with each candidate track-train assignment sequence.

In embodiments, the alternative ramp plan schedules generated by the re-optimization process are then presented to the operator. The operator can review these alternative schedules and select the one that is the optimum under the new conditions to commit for execution (e.g., during the time period represented by the timeline). This ensures that the operator has the flexibility to make changes to the processing schedule of a train, while still maintaining the overall efficiency and effectiveness of the hub operation. For example, GUI Manager 325 may enable operators with the option to cycle through various proposed ramp plan schedules, including those that may not be the absolute optimum but still meet the operational objectives.

In embodiments, intelligent GUI provided by GUI manager 325 may be equipped with a notifications center, designed to alert operators to any deviations from the optimized plan and/or other emergent issues that require attention. These notifications ensure that operators are promptly informed of any changes in train arrivals, resource availability, or other operational contingencies, enabling them to take swift and informed action. For example, in some embodiments, the notification center may operate to provide an indication that another hub may be requesting to re-route a train to the hub. In this case, the other hub may not have capacity to process the train, or may determine that processing the train at this hub results in a higher throughput (e.g., the units may be made available to the customer sooner than if processed at the other hub).

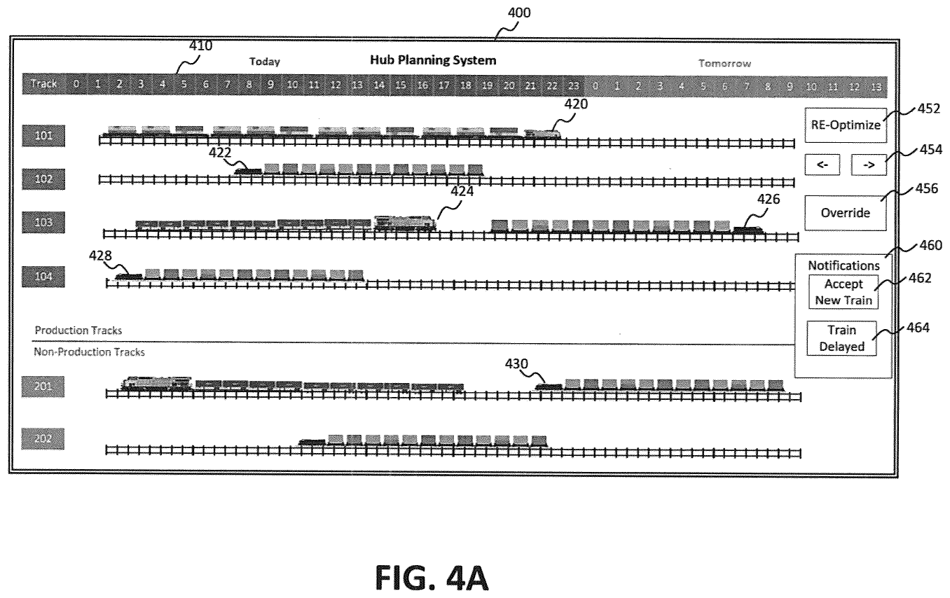

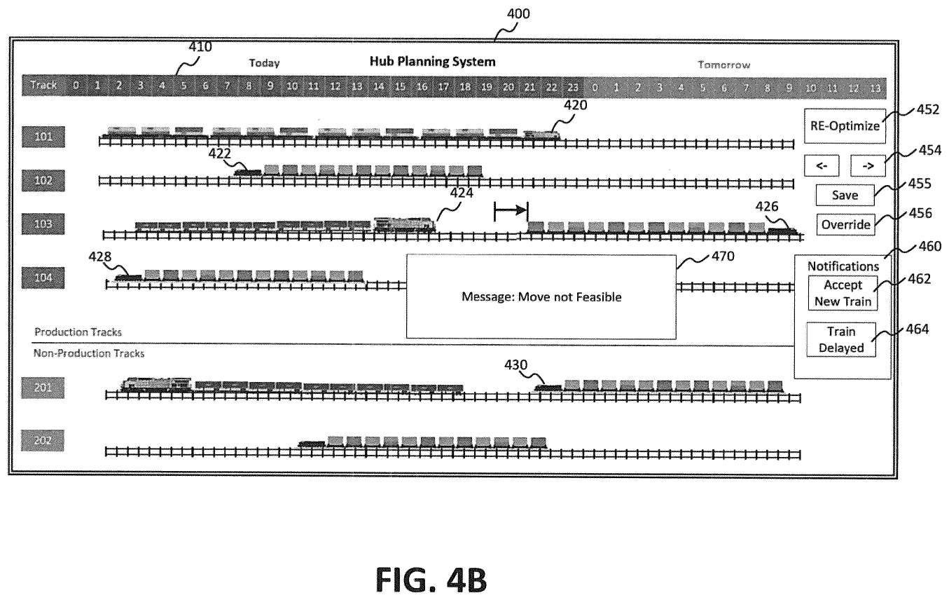

FIG. 4A illustrates an exemplary intelligent graphical user interface (GUI) 400 configured for advanced scheduling and optimization of ramp operations of a hub in accordance with embodiments of the present disclosure. Intelligent GUI 400 may represent an interactive tool designed to provide operators with a dynamic and intuitive visual representation of ramp operations, including the scheduling and processing of trains on production and non-production tracks within an intermodal hub facility. As such, intelligent GUI 400 represents an advanced visualization and management tool that enhances the operator's control over ramp operations, by providing a comprehensive, temporally-aware visualization of the ramp plan, supports dynamic optimization and re-optimization based on operator input, and facilitates informed decision-making through interactive features and real-time notifications.

Intelligent GUI 400 includes timeline 410, representing a temporal representation of the hub's production tracks, including production track 101, production track 102, production track 103, and production track 104, as well as non-production tracks such as non-production track 201 and non-production track 202, over a timeframe. In this example, each production track is represented as a horizontal line across the GUI, with time progressing from left to right along the timeframe 410. In this example, the timeframe represented by timeline 410 runs from 00:00 hours today to 13:00 hours tomorrow.

Intelligent GUI 400 depicts scheduled trains as train graphics (e.g., a graphical representation of a train) along the tracks, with the length of each train graphic corresponding to the processing time of the train. This visual approach allows operators to quickly assess the duration and timing of each train's processing. The trains include outbound train 420, outbound train 424, outbound train 426, inbound train 422, inbound train 428, and inbound train 430. The positioning of these train representations along the timeframe 410 indicates the scheduled processing times for each train. For example, the representation of outbound train 420 on production track 101 has a length that runs from approximately 01:00 to 23:00 hours, representing that the duration and timing of outbound train 420's processing on production track 101 is scheduled to run from 01:00 to 23:00 hours. Similarly, the representation of inbound train 422 on production track 102 has a length that runs from approximately 07:00 to 19:00 hours, representing that the duration and timing of inbound train 422's processing on production track 102 is scheduled to run from 07:00 to 19:00 hours. The representation of outbound train 424 on production track 103 has a length that runs from approximately 02:00 to 17:00 hours, representing that the duration and timing of outbound train 424's processing on production track 103 is scheduled to run from 02:00 to 17:00 hours. The representation of outbound train 426 on production track 103 has a length that runs from approximately 19:00 hours today to 08:00 hours tomorrow, representing that the duration and timing of outbound train 426's processing on production track 103 is scheduled to run from 19:00 hours today to 08:00 hours tomorrow. The representation of inbound train 428 on production track 104 has a length that runs from approximately 02:00 to 14:00 hours, representing that the duration and timing of inbound train 428's processing on production track 104 is scheduled to run from 02:00 to 14:00 hours.

Intelligent GUI 400 may be interactive, enabling operators to adjust the processing schedule by dragging train representations to different times or tracks. This functionality allows for on-the-fly modifications to the ramp plan, accommodating real-time operational changes or preferences. For example, an operator may decide to adjust the ramp plan schedule illustrated in FIG. 4A. In particular, the operator may decide to change the scheduled processing time of outbound train 426 to another time. For example, as shown in FIG. 4B, the operator may decide to change the scheduled processing time of outbound train 426 from approximately 19:00 hours today to 08:00 hours tomorrow to a new timeframe starting at approximately 21:00 hours today to 10:00 hours tomorrow (e.g., delaying the processing time of outbound train 426 by two hours). In this case, the operator may request the change by dragging or sliding the graphical representation of train 426 to the new processing time, as seen in FIG. 4B. Although in this example the operator has dragged the graphical representation of train 426 to the new processing time on the same production track 101, the operator may drag the graphical representation of train 426 to a new production track (e.g., production track 104) to represent a request to change the processing of outbound train 426 to another production track, namely production track 104.

In this example, after adjusting the schedule by moving or sliding outbound train 426 to the new processing timeframe, the operator may request that the system re-optimize the ramp plan schedule based on the adjustment. For example, the operator may select re-optimize selectable element 452 to request the re-optimization of the ramp operations plan schedule. The system (e.g., in conjunction with optimization system 320) may evaluate the proposed changes and dynamically adapts the schedule and/or may provide alternative schedules that maintain or enhance operational efficiency.

In this example, selectable elements 454 may be used by the operator to cycle through one or more of the proposed alternative schedules that are generated in response to the request to-re-optimize the ramp plan schedule. The operator may cycle through the alternative schedules to review and select from the various proposed schedules, including those that may not be the absolute optimum but still meet operational objectives. The operator may select one of the proposed schedules by selecting the save selectable element 455 to activate the selected ramp plan schedule. Saving the selected schedule may commit the schedule for execution (e.g., for execution during the time period represented by timeline 410). Alternatively, the operator may reject the proposed alternative ramp plan schedules by selecting the override selectable element 456, in which case the original ramp plan schedule may be implemented but with the single modification that outbound train 426 is scheduled to be processed during the new timeframe (e.g., from approximately 21:00 hours today to 10:00 hours tomorrow) rather than the original timeframe (e.g., from approximately 19:00 hours today to 08:00 hours tomorrow).

In some embodiments, override selectable element 456 may enable the operator to cause the system to forgo re-optimizing, and simply implement the changes to the current ramp plan schedule without re-optimizing the ramp plan schedule.

In some embodiments, the system may determine whether the proposed change, such as the change to the processing timeframe of outbound train 426, is feasible or not. In this case, the system may reassess the allocation of resources, the sequencing of train operations, and the timing of each train's processing according to the present ramp plan schedule and may determine whether the proposed change is feasible or not. In embodiments, in response to a determination that the proposed change is feasible, the system may allow the change. In embodiments, in response to a determination that the proposed change is feasible, the system may not allow the change, and/or intelligent GUI 400 may display a message 470 indicating that the proposed action or change by the operator is not feasible.

Intelligent GUI 400 features a notifications center 460, which serves as a hub for alerts and notifications. The notifications provide operators with real-time updates on deviations from the optimized plan or emergent issues that require immediate attention. This ensures that operators are kept informed and can take prompt action to address any operational contingencies. For example, as shown in FIG. 4A, intelligent GUI 400 may display a first notification 462 indicating a request to add a new train to the current ramp plan schedule. For example, a train not previously schedule to be processed at the hub over the timeline 410 may be requested, such as by another hub or based on other operational requirements, to be processed at the hub over the timeline 410. In this case, the operator may select the notification and/or may select the train to be added or a symbol representing the type of train to be added. The operator may add the new train by positioning a graphical representation of the train along the timeline 410 on one of the production tracks. Alternatively, the operator may select the train to be added, and may then select the re-optimize selectable element 452 to cause the system to re-optimize the ramp plan schedule including the new train, and may receive one or more propose schedules, through which the operator may cycle and select, as described above with respect to selectable elements 454-456.

In another example, a second notification 464 may provide an indication that a particular train may have been delayed. In this case, the operator may adjust the ramp plan schedule based on the notified delay, and/or may request the system to re-optimize the ramp plan schedule based on the delayed train.

FIG. 7 shows a high-level flow diagram 700 of operation of a system configured for providing functionality for optimizing ramp operations of a hub in accordance with embodiments of the present disclosure. For example, the functions illustrated in the example blocks shown in FIG. 7 may be performed by system 100 of FIG. 1 according to embodiments herein. In embodiments, the operations of the method 700 may be stored as instructions that, when executed by one or more processors, cause the one or more processors to perform the operations of the method 700.

At block 502, a representation of an optimized ramp operations schedule over a period of time for one or more inbound and outbound trains scheduled to be processed at a hub over the period of time is displayed on the GUI. In embodiments, the representation of the optimized ramp operations schedule includes a graphical representation of a status of one or more production tracks of the hub over the period of time overlayed with a representation of the one or more inbound and outbound trains scheduled to be processed at the hub placed correspondingly to a time within the period of time at which the respective train is to be processed. In embodiments, functionality of a GUI manager (e.g., GUI manager 325 as illustrated in FIG. 3) may be used to display, on the GUI, a representation of an optimized ramp operations schedule over a period of time for one or more inbound and outbound trains scheduled to be processed at a hub over the period of time. In embodiments, the GUI manager may perform operations to display, on the GUI, a representation of an optimized ramp operations schedule over a period of time for one or more inbound and outbound trains scheduled to be processed at a hub over the period of time according to operations and functionality as described above with reference to GUI manager 325 and as illustrated in FIGS. 1-4B.

At block 504, a user request to modify a processing time of at least one of the one or more inbound and outbound trains in the optimized ramp operations schedule is received via the GUI. In embodiments, functionality of a GUI manager (e.g., GUI manager 325 as illustrated in FIG. 3) may be used to receive, via the GUI, a user request to modify a processing time of at least one of the one or more inbound and outbound trains in the optimized ramp operations schedule. In embodiments, the GUI manager may perform operations to receive, via the GUI, a user request to modify a processing time of at least one of the one or more inbound and outbound trains in the optimized ramp operations schedule according to operations and functionality as described above with reference to GUI manager 325 and as illustrated in FIGS. 1-4B.

At block 506, the optimized ramp operations schedule is re-optimized, by a ramp operations optimization system based on the request to modify the processing time of the at least one of the one or more inbound and outbound trains to generate one or more optimized ramp operations schedule options. In embodiments, functionality of an optimization system (e.g., optimization system 320 as illustrated in FIG. 3) may be used to re-optimize, by a ramp operations optimization system, the optimized ramp operations schedule based on the request to modify the processing time of the at least one of the one or more inbound and outbound trains to generate one or more optimized ramp operations schedule options. In embodiments, the optimization system may perform operations to re-optimize, by a ramp operations optimization system, the optimized ramp operations schedule based on the request to modify the processing time of the at least one of the one or more inbound and outbound trains to generate one or more optimized ramp operations schedule options according to operations and functionality as described above with reference to optimization system 320 and as illustrated in FIGS. 1-4B.

At block 508, the one or more optimized ramp operations schedule options are visually indicated on the GUI. In embodiments, functionality of a GUI manager (e.g., GUI manager 325 as illustrated in FIG. 3) may be used to visually indicate, on the GUI, the one or more optimized ramp operations schedule options. In embodiments, the GUI manager may perform operations to visually indicate, on the GUI, the one or more optimized ramp operations schedule options according to operations and functionality as described above with reference to GUI manager 325 and as illustrated in FIGS. 1-4B.

At block 510, one of the one or more optimized ramp operations schedule options is committed for execution. In embodiments, functionality of a GUI manager (e.g., GUI manager 325 as illustrated in FIG. 3) may be used to commit one of the one or more optimized ramp operations schedule options for execution. In embodiments, the GUI manager may perform operations to commit one of the one or more optimized ramp operations schedule options for execution according to operations and functionality as described above with reference to GUI manager 325 and as illustrated in FIGS. 1-4B.

At block 510, a control signal is automatically sent to a controller to cause execution of the committed re-optimized ramp operations. In embodiments, functionality of an operations server (e.g., operations server 125 as illustrated in FIGS. 1-3) may be used automatically send, during execution of the optimized operating schedule, a control signal to a controller to cause execution of the committed re-optimized ramp operations. In embodiments, the operations server may perform operations to automatically send, during execution of the optimized operating schedule, a control signal to a controller to cause execution of the committed re-optimized ramp operations according to operations and functionality as described above with reference to operations server 125 and as illustrated in FIGS. 1-4B.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112 (f). Even under the broadest reasonable interpretation, in light of this paragraph of this specification, the claims are not intended to invoke 35 U.S.C. § 112 (f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosure can be established by the appended claims. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

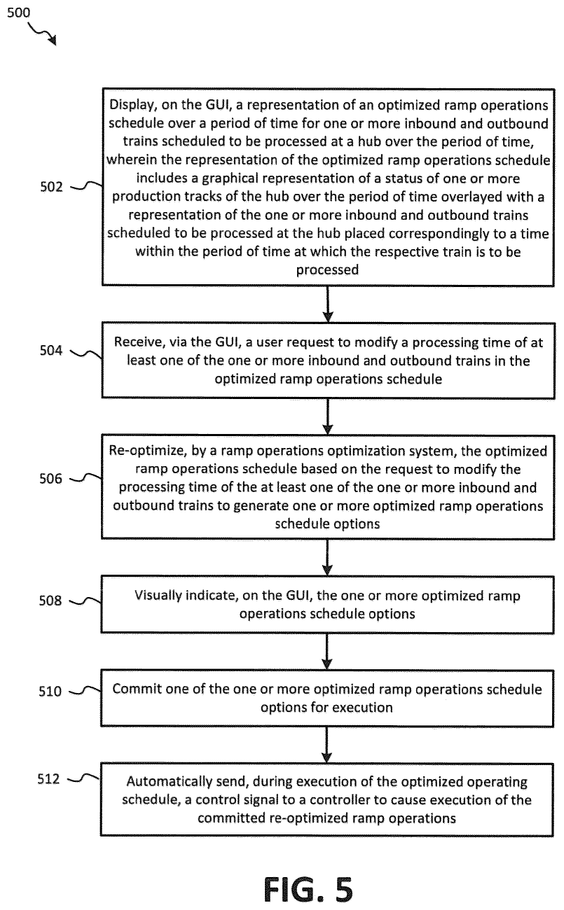

Functional blocks and modules in FIGS. 1-5 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method of advanced scheduling and optimization of ramp operations of a hub based on an intelligent graphical user interface (GUI), the method comprising:
displaying, on the intelligent GUI, a representation of an optimized ramp operations schedule over a period of time for one or more inbound and outbound trains scheduled to be processed at a hub over the period of time, wherein the representation of the optimized ramp operations schedule includes a graphical representation of a status of one or more production tracks of the hub over the period of time overlayed with a representation of the one or more inbound and outbound trains scheduled to be processed at the hub placed correspondingly to a time within the period of time at which the respective train is to be processed;
receiving, via the intelligent GUI, a user request to modify a processing time of at least one of the one or more inbound and outbound trains in the optimized ramp operations schedule;
re-optimizing, by a ramp operations optimization system, the optimized ramp operations schedule based on the request to modify the processing time of the at least one of the one or more inbound and outbound trains to generate one or more optimized ramp operations schedule options;
visually indicating, on the intelligent GUI, the one or more optimized ramp operations schedule options;
committing one of the one or more optimized ramp operations schedule options for execution; and
automatically sending, during execution of the optimized operating schedule, a control signal to a controller to cause execution of the committed re-optimized ramp operations.

2. The method of claim 1, wherein the user request to modify the processing time of at least one of the one or more inbound and outbound trains includes utilizing sliding and dragging functionality within the intelligent GUI to change the processing schedule of the train.

3. The method of claim 1, wherein visually indicating the one or more optimized ramp operations schedule options on the intelligent GUI includes enabling the user to cycle through the one or more optimized ramp operations schedule options to review potential impacts on the ramp operations schedule.

4. The method of claim 1, wherein committing one of the one or more optimized ramp operations schedule options for execution includes the ramp operations optimization system automatically selecting an optimized ramp operations schedule option based on predefined criteria.

5. The method of claim 1, wherein committing one of the one or more optimized ramp operations schedule options for execution includes allowing the user to select one of the optimized ramp operations schedule options via the intelligent GUI and then committing the selected option.

6. The method of claim 1, further comprising:
allowing the user to reject all of the one or more optimized ramp operations schedule options and maintain the original ramp operations schedule including the modification of the processing time of the at least one of the one or more inbound and outbound trains.

7. The method of claim 1, wherein committing one of the one or more optimized ramp operations schedule options for execution includes sending a notification to execute the committed re-optimized ramp operations schedule during the timeframe represented by the schedule during operations.

8. A system configured for advanced scheduling and optimization of ramp operations of a hub based on an intelligent graphical user interface (GUI), comprising:
at least one processor; and
a memory operably coupled to the at least one processor and storing processor-readable code that, when executed by the at least one processor, is configured to perform operations including:
displaying, on the intelligent GUI, a representation of an optimized ramp operations schedule over a period of time for one or more inbound and outbound trains scheduled to be processed at a hub over the period of time, wherein the representation of the optimized ramp operations schedule includes a graphical representation of a status of one or more production tracks of the hub over the period of time overlayed with a representation of the one or more inbound and outbound trains scheduled to be processed at the hub placed correspondingly to a time within the period of time at which the respective train is to be processed;
receiving, via the intelligent GUI, a user request to modify a processing time of at least one of the one or more inbound and outbound trains in the optimized ramp operations schedule;
re-optimizing, by a ramp operations optimization system, the optimized ramp operations schedule based on the request to modify the processing time of the at least one of the one or more inbound and outbound trains to generate one or more optimized ramp operations schedule options;
visually indicating, on the intelligent GUI, the one or more optimized ramp operations schedule options;
committing one of the one or more optimized ramp operations schedule options for execution; and
automatically sending, during execution of the optimized operating schedule, a control signal to a controller to cause execution of the committed re-optimized ramp operations.

9. The system of claim 8, wherein the user request to modify the processing time of at least one of the one or more inbound and outbound trains includes utilizing sliding and dragging functionality within the intelligent GUI to change the processing schedule of the train.

10. The system of claim 8, wherein visually indicating the one or more optimized ramp operations schedule options on the intelligent GUI includes enabling the user to cycle through the one or more optimized ramp operations schedule options to review potential impacts on the ramp operations schedule.

11. The system of claim 8, wherein committing one of the one or more optimized ramp operations schedule options for execution includes the ramp operations optimization system automatically selecting an optimized ramp operations schedule option based on predefined criteria.

12. The system of claim 8, wherein committing one of the one or more optimized ramp operations schedule options for execution includes allowing the user to select one of the optimized ramp operations schedule options via the intelligent GUI and then committing the selected option.

13. The system of claim 8, wherein the operations further comprise:
allowing the user to reject all of the one or more optimized ramp operations schedule options and maintain the original ramp operations schedule including the modification of the processing time of the at least one of the one or more inbound and outbound trains.

14. The system of claim 8, wherein committing one of the one or more optimized ramp operations schedule options for execution includes sending a notification to execute the committed re-optimized ramp operations schedule during the timeframe represented by the schedule during operations.

15. A computer-based tool for advanced scheduling and optimization of ramp operations of a hub based on an intelligent graphical user interface (GUI), the computer-based tool including non-transitory computer readable media having stored thereon computer code which, when executed by a processor, causes a computing device to perform operations comprising:
displaying, on the intelligent GUI, a representation of an optimized ramp operations schedule over a period of time for one or more inbound and outbound trains scheduled to be processed at a hub over the period of time, wherein the representation of the optimized ramp operations schedule includes a graphical representation of a status of one or more production tracks of the hub over the period of time overlayed with a representation of the one or more inbound and outbound trains scheduled to be processed at the hub placed correspondingly to a time within the period of time at which the respective train is to be processed;
receiving, via the intelligent GUI, a user request to modify a processing time of at least one of the one or more inbound and outbound trains in the optimized ramp operations schedule;
re-optimizing, by a ramp operations optimization system, the optimized ramp operations schedule based on the request to modify the processing time of the at least one of the one or more inbound and outbound trains to generate one or more optimized ramp operations schedule options;
visually indicating, on the intelligent GUI, the one or more optimized ramp operations schedule options;
committing one of the one or more optimized ramp operations schedule options for execution; and
automatically sending, during execution of the optimized operating schedule, a control signal to a controller to cause execution of the committed re-optimized ramp operations.

16. The computer-based tool of claim 15, wherein the user request to modify the processing time of at least one of the one or more inbound and outbound trains includes utilizing sliding and dragging functionality within the intelligent GUI to change the processing schedule of the train.

17. The computer-based tool of claim 15, wherein visually indicating the one or more optimized ramp operations schedule options on the intelligent GUI includes enabling the user to cycle through the one or more optimized ramp operations schedule options to review potential impacts on the ramp operations schedule.

18. The computer-based tool of claim 15, wherein committing one of the one or more optimized ramp operations schedule options for execution includes the ramp operations optimization system automatically selecting an optimized ramp operations schedule option based on predefined criteria.

19. The computer-based tool of claim 15, wherein committing one of the one or more optimized ramp operations schedule options for execution includes allowing the user to select one of the optimized ramp operations schedule options via the intelligent GUI and then committing the selected option.

20. The computer-based tool of claim 15, wherein the operations further comprise:
allowing the user to reject all of the one or more optimized ramp operations schedule options and maintain the original ramp operations schedule including the modification of the processing time of the at least one of the one or more inbound and outbound trains.
